(19) United States
(12) Patent Application Publication
(10) Pub. No.: US 2025/0055051 A1
(43) Pub. Date: Feb. 13, 2025

(54) Battery Storage Device With a Safety Device, and Method for Triggering the Safety Device

(71) Applicant: Bayerische Motoren Werke Aktiengesellschaft, Muenchen (DE)

(72) Inventors: Alexander ADAM, Muenchen (DE); Roland JUNG, Muenchen (DE); Sebastian SCHARNER, Tuerkenfeld (DE); Thomas WOEHRLE, Muenchen (DE)

(21) Appl. No.: 18/717,480

(22) PCT Filed: Nov. 23, 2022
(86) PCT No.: PCT/EP2022/083018

§ 371 Date: Jun. 7, 2024

(30) Foreign Application Priority Data
Dec. 10, 2021 (DE) 10 2021 132 742.3

(51) Int. Cl. H01M 10/52; H01M 10/0567; H01M 10/48; H01M 50/204; H01M 50/673

(52) U.S. Cl. CPC H01M 10/52; H01M 10/0567; H01M 10/482; H01M 50/204; H01M 50/673

(57) ABSTRACT

A battery storage device includes a storage housing and at least one battery cell which is arranged in the interior of the storage housing and contains an electrolyte based on sulfur dioxide. The battery storage device has a safety apparatus with a metering device which includes a foam-forming additive. The metering device is configured to produce a foam from the foam-forming additive in order to neutralize the electrolyte, and to release the foam in the interior of the storage housing.

### BACKGROUND AND SUMMARY

The present invention relates to a battery storage device having a safety apparatus and to a method for triggering the safety apparatus.

Electrochemical cells are of great significance in many technical fields. For example, electrochemical cells are frequently used for mobile applications, such as for the operation of laptops, e-bikes or mobile phones. An advantage of electrochemical cells is that they can be connected to one another in series or in parallel, in order to form higher-energy batteries. Such batteries can be combined in what is referred to as a battery storage device and are also suitable, inter alia, for high-voltage applications. For example, battery storage devices can make it possible to electrically drive vehicles or be used as stationary energy storage devices.

In the following text, the term “electrochemical cell” is used synonymously for all designations common in the prior art for rechargeable galvanic elements, such as cells, batteries, battery cells, accumulators, battery accumulators and secondary batteries.

An electrochemical cell is able to make electrons available for an external power circuit during a discharging operation. Conversely, an electrochemical call can be charged by the supply of electrons by means of an external power circuit during a charging operation.

An electrochemical cell has at least two different electrodes: a positive electrode (cathode) and a negative electrode (anode). Both electrodes are in contact with a separator, which is an electrical insulator. An example of a prior art separator is a porous polyolefin separator, which is impregnated with a liquid electrolyte composition. The separator separates the two electrodes from one another spatially and connects the two electrodes to one another ion-conductively.

The most commonly used electrochemical cell is the lithium-ion cell, also referred to as a lithium-ion battery. Lithium-ion cells from the prior art typically have a composite anode very often comprising a carbon-based anode active material, typically graphitic carbon, which is generally coated onto a metallic copper substrate foil with an electrode binder. Generally, the composite cathode comprises a positive cathode active material, for example a layered oxide, a binder and an electrical conductivity additive, which are, for example, deposited on a rolled aluminum collector foil. The layered oxide very often comprises LiCoO₂ or LiNi_{1/3}Mn_{1/3}Co_{1/3}O₂.

Typically, lithium-ion batteries comprise a liquid electrolyte composition, which ensures charge equalization between the cathode and the anode during the charging and discharging operations. The flow of current required for this is achieved by the transport of ions of a conductive salt in the electrolyte composition. In the case of lithium-ion cells, the conductive salt is a conductive lithium salt (for example LiPF₆, LiBF₄) and the disassociated lithium ions move in the electrical field between the electrodes.

In addition to the conductive lithium salt, electrolyte compositions contain a solvent, which enables disassociation of the conductive salt and sufficient mobility of the lithium ions. Liquid organic solvents comprising a selection of linear and cyclic dialkyl carbonates are known from the prior art. Use is generally made of mixtures of ethylene carbonate (EC), dimethyl carbonate (DMC), diethyl carbonate (DEC), propylene carbonate (PC) and ethyl methyl carbonate (EMC). The solvents cited here each have a specific stability range in which they operate stably at a given cell voltage. This range is also known as the voltage window. The electrochemical cell can run stably during operation within the voltage window. On approaching the limits of the voltage window, electrochemical oxidation or reduction of the constituents of the electrolyte composition takes place. Efforts are therefore being made to use electrolytes which have a higher stability with respect to various cell voltages.

A further development of lithium-ion batteries with an organic electrolyte is therefore lithium-ion batteries with an inorganic electrolyte based on the solvent sulfur dioxide. Various approaches for stable electrolyte compositions based on sulfur dioxide are known in the prior art.

EP 1 201 004 Bi discloses a rechargeable electrochemical cell with a sulfur dioxide-based electrolyte. In this case, sulfur dioxide is not added as an additional substance, but instead constitutes the main constituent as solvent for the conductive salt of the electrolyte composition. Therefore, it should at least partially ensure the mobility of the lithium ions of the conductive salt, which bring about the transport of ions between the electrodes. In the proposed cells, lithium tetrachloroaluminate (LiAlCl₄) is used as conductive lithium-containing salt in combination with a cathode active material made of a transition metal oxide, in particular an intercalation compound such as lithium cobalt oxide (LiCoO₂). As a result of the addition of a salt additive, for example an alkali metal halide such as lithium fluoride, sodium chloride or lithium chloride, to the sulfur dioxide-containing electrolyte composition, functioning and rechargeable cells were obtained.

EP 2534719 B1 describes a rechargeable lithium battery cell comprising a sulfur dioxide-based electrolyte in combination with lithium iron phosphate (LFP) as cathode active material. The preferred conductive salt used in the electrolyte composition was lithium tetrachloroaluminate. In tests with cells on the basis of these components, it was possible to prove a high electrochemical stability of the cells.

WO 2015/043573 A2 describes a rechargeable electrochemical battery cell with a housing, a positive electrode, a negative electrode and an electrolyte containing sulfur dioxide and a conductive salt, at least one of the electrodes containing a binder selected from the group consisting of binder A, which consists of a polymer formed of monomer structural units of a conjugated carboxylic acid or of the alkali metal, alkali earth metal or ammonium salt of this conjugated carboxylic acid or the combination thereof, and binder B, which consists of a polymer based on monomer styrene and butadiene structural units, or a mixture of binders A and B.

WO 2021/019042 A1 describes rechargeable battery cells comprising an active metal, a layered oxide as cathode active material and a sulfur dioxide-containing electrolyte. Owing to the poor solubility of many conventional conductive lithium salts in sulfur dioxide, a conductive salt of formula M⁺[Z(OR)₄]⁻ was used in the cells, where M constitutes a metal selected from the group consisting of alkali metals, alkali earth metals and a metal from Group 12 of the Periodic Table of the Elements, and R is a hydrocarbon radical. The alkoxy groups —OR are each monovalently bonded to the central atom, which can be aluminum or boron. In a preferred embodiment, the cells contain a conductive perfluorinated salt of formula Li⁺[Al(OC(CF₃)₃)₄]⁻. Cells consisting of the components described exhibit stable electrochemical performance in experimental studies. In addition, the conductive salts, in particular the perfluorinated anion, have a surprising hydrolysis stability. The electrolytes should also be oxidation-stable to an upper potential of 5.0 V. It was also found that cells comprising the electrolytes disclosed can be discharged and charged at very low temperatures of down to −41° C.

German patent application no. 10 2021 118 811.3, unpublished on the priority date of the present application, also discloses a liquid electrolyte composition on the basis of sulfur dioxide for an electrochemical cell. The electrolyte composition comprises the following components: A) sulfur dioxide; B) at least one salt, the salt containing an anionic complex comprising at least one bidentate ligand. The counterion of the anionic complex is a metal cation, selected from the group consisting of alkali metals, alkali earth metals and metals of Group 12 of the Period Table of the Elements. The central ion Z of the complex is selected from the group consisting of aluminum and boron. The bidentate ligand forms a ring with the central ion Z and with two oxygen atoms bonded to the central ion Z and the bridging group, the ring containing a continuous sequence of 2 to 5 carbon atoms. An electrochemical cell, in particular a lithium-ion cell, comprising the aforementioned electrolyte composition is furthermore proposed.

Cells comprising a sulfur dioxide-based electrolyte are furthermore known from EP 3 703 161 A1, EP 2 227 838 B1, EP 2 742 551 B1, EP 3 771 011 A2, WO 2005/031908 A2 and WO 2014/121803 A1, to which reference is made here.

In the case of a mechanical, electrical or thermal defect of the battery cells, in particular of lithium-ion cells comprising a sulfur dioxide-based electrolyte composition, opening of the cell and thus release of electrolyte constituents from the cell, in particular gaseous electrolyte constituents such as sulfur dioxide, can occur.

This disclosure is based on the object of preventing transfer of the electrolyte into the surrounding area in the event of such damage to a cell comprising a sulfur dioxide-based electrolyte.

The object may be achieved according to the disclosure by a battery storage device comprising a safety apparatus and at least one battery cell according to the independent claim.

Advantageous embodiments of the battery storage device according to the invention are specified in the dependent claims and the figures, which can be selectively combined with one another.

According to this disclosure, the object may be achieved by a battery storage device comprising a storage housing and at least one battery cell which is positioned in an interior space of the storage housing and contains a sulfur dioxide-based electrolyte. The battery storage device further comprises a safety apparatus with a metering device which comprises a foam-forming additive and is designed to produce a foam for neutralizing the electrolyte from the foam-forming additive and to release the foam in the interior space of the storage housing.

The basic concept of the technology is that, in the event of a mechanical, thermal or electrical defect of a cell, the proposed battery storage device comprises a safety apparatus, which may, by releasing a foam, neutralize or bind a sulfur dioxide-based electrolyte emerging from a cell.

It is therefore possible to afford the technical advantage that the emerging electrolyte can be quickly and safely absorbed and easily neutralized or bound by the large surface area of the foam.

In this disclosure, neutralization of the electrolyte is understood to mean chemical neutralization, which converts the electrolyte constituents, in particular sulfur dioxide, into chemically more stable and less toxic compounds.

Furthermore, at the same time, the advantage that the electrolyte is neutralized already in the interior space of the storage housing is afforded. Since the storage housing in particular is liquid-tight, the foam, the electrolyte and other constituents remain in the battery storage device after the neutralizing. The storage housing therefore provides a defined and spatially delimited reaction chamber in which the chemical neutralization can be carried out under controlled conditions. Advantageously, the battery storage device can be disposed of individually or fed to a recycling process after the neutralization has ended.

A technical advantage in the use of a foam includes in particular that the released foam can fix the emerging electrolyte in place. Individual constituents of the electrolyte can be adsorbed on the bubble skin of the foam and are thus bonded to the foam. Electrolyte constituents can similarly be incorporated in the bubbles of the foam. In both cases, the emerging electrolyte can have its movement limited and be quickly fixed in place in the interior space of the storage housing. Furthermore, the electrolyte fixed in place in this way can be neutralized owing to the chemical nature of the foam itself. More specifically, the electrolyte can undergo a chemical reaction with the foam constituents, as a result of which the electrolyte can be neutralized and converted into more chemically stable compounds. Since the foam also fixes the electrolyte in place at the same time, the electrolyte can be neutralized particularly completely and efficiently.

The proposed battery storage device is preferably placed in a vehicle and is used to electrically drive the vehicle. Of course, multiple battery storage devices may also be placed in such a vehicle. The battery storage device according to the invention is not restricted to mobile applications such as vehicles and can also be used for stationary operation. For example, the battery storage device according to the invention can be used to store energy from solar plants and wind farms.

Within the context of this disclosure, a battery storage device means a storage housing, in the interior space of which at least one battery cell, preferably multiple battery cells, is/are placed. The battery cells may be connected to one another in the storage housing, in order to provide a higher energy. A battery cell is understood to mean an electrochemical cell comprising a sulfur dioxide-based electrolyte. The battery cell is preferably a lithium-ion cell.

The technology is not further restricted in terms of the sulfur dioxide-based electrolyte composition. It is therefore possible to use any of the sulfur dioxide-based electrolyte compositions that are known in the prior art.

In particular, a sulfur dioxide-based electrolyte is understood to mean a liquid electrolyte composition which contains sulfur dioxide as constituent. The sulfur dioxide may be present in the electrolyte composition as a liquid, as a gas or bonded in a complex.

Suitable examples of such electrolyte compositions are known from EP 1 201 004 B1, EP 2 534 719 B1, WO 2015/043573 A2, WO 2021/019042 A1, EP 3 703 161 A1, EP 2 227 838 B1, EP 2 742 551 B1, EP 3 771 011 A2, WO 2005 031908 A2 and WO 2014 121803 A1 and also from German patent application no. 10 2021 118 811.3, unpublished on the priority date of the present application, to which reference is made here.

In an advantageous aspect of the technology, the foam-forming additive may be present in an aqueous solution.

The foam-forming additive may comprise at least one foaming agent. The technology is not further restricted in terms of the foaming agent. In general, any foaming agents that are known in the prior art can be used for the foam-forming additive.

Foaming agents that can be used include, inter alia, protein foams, fluoroprotein foams, aqueous film-forming protein foaming agents, multipurpose foaming agents and alcohol-resistant foaming agents.

The foam-forming additive is preferably selected from the group consisting of ionic surfactants, saponins and proteins, and combinations of these.

Suitable examples of foaming agents include alkylbenzenesulfonate, fatty alcohol polyglycol ether sulfates, alkanesulfonates, alkyl ether carboxylates, betaines, fatty acid sulfoalkylamides, fatty acid sulfoalkyl ester, sodium lauryl sulfoacetate, sodium lauroyl sarcosinate, sodium lauryl ether sulfate, sodium dodecyl sulfate, coconut fatty acid monoglyceride sulfate, docusate sodium, sodium lauryl sulfoacetate, sodium lauroyl sarcosinate and sodium dodecyl sulfate, and combinations of these.

The proposed foaming agents may have the technical advantage that they have excellent availability at low cost and can be mixed very readily with water.

The foam-forming additive may comprise 0.1-6 wt. % of the foaming agent, preferably 4-6 percent by weight, particularly preferably 5-6 wt. %, based on the overall weight of the foam-forming additive.

The foam-forming additive may also comprise a base. The technology is not further restricted in terms of the base. In general, any bases that are known in the prior art can be used for the foam-forming additive.

For example, the base can be a porous natural lime.

The base is preferably selected from the group consisting of carbonates, hydrogen carbonates, oxides and hydroxides, and combinations of these.

Carbonates that may be used are in particular metal carbonates, preferably alkali metal and alkali earth metal carbonates. Suitable examples of carbonates are barium carbonate, calcium carbonate, magnesium carbonate, potassium carbonate, sodium carbonate and zinc carbonate, and combinations of these.

Hydrogen carbonates that may be used are in particular metal hydrogen carbonates, preferably alkali metal and alkali earth metal hydrogen carbonates. Suitable examples of hydrogen carbonates include calcium hydrogen carbonate, magnesium hydrogen carbonate, barium hydrogen carbonate, strontium hydrogen carbonate, sodium hydrogen carbonate and potassium hydrogen carbonate, and combinations of these.

Oxides that may be used may in particular be metal oxides, preferably alkali metal and alkali earth metal oxides. Suitable examples of oxides include lithium oxide, sodium oxide, potassium oxide, magnesium oxide, calcium oxide, strontium oxide and barium oxide, and combinations of these.

Hydroxides that may be used are in particular metal hydroxides, preferably alkali metal and alkali earth metal hydroxides. Examples of hydroxides include in particular lithium hydroxide, sodium hydroxide, potassium hydroxide, calcium hydroxide, barium hydroxide, strontium hydroxide and zinc hydroxide, and combinations of these.

Since the foam-forming additive may be present in an aqueous solution, the base may also be present in an aqueous solution. The base is preferably dissolved in the aqueous solution.

In an advantageous embodiment of the technology, the aqueous solution is a solution saturated by the base. Owing to the high base content, the saturated solutions may have a particularly high ion concentration. The ion concentration preferably corresponds to the solubility product of the respective base. Aqueous solutions with such a base concentration may remain liquid even below the freezing point of water. Consequently, the base may additionally serve as antifreeze agent. Such saturated solutions may be suitable in particular for operation or use in a vehicle.

The additive particularly preferably comprises a saturated, aqueous solution of sodium carbonate, further preferably an aqueous, saturated solution of potassium carbonate, and combinations of these.

Providing a base in the foam-forming additive advantageously makes it possible to directly neutralize the sulfur dioxide-based electrolyte in the form of acid/base neutralization.

The sulfur dioxide present in the electrolyte dissolves particularly readily in water and can therefore be absorbed particularly well. The solubility of sulfur dioxide in water is 112.7 g of sulfur dioxide per 1 1 of water at 20° C. Sulfur dioxide reacts with water to form sulfuric acid, which can react with the base again in a neutralization reaction. The base can therefore convert the sulfur dioxide dissolved in the aqueous solution into more stable chemical compounds. For example, the sulfur dioxide can be converted into stable sulfites or sulfates and/or hydrogen sulfites by carbonates. Furthermore, the base affords the technical advantage that it is not toxic, is readily soluble in water and has excellent availability.

The foam-forming additive may also comprise further additional substances.

Suitable examples of additional substances include alkali earth metal chlorides, flame retardants, higher alcohols and urea, and combinations of these. Higher alcohols are in particular saturated, mono- to trihydric alcohols with two to 12 C atoms, the higher alcohols possibly comprising primary, secondary or tertiary hydroxyl groups. Calcium chloride (CaCl₂)) is particularly preferably used as alkali earth metal chloride.

The addition of calcium chloride may afford the technical advantage that the absorption of sulfur dioxide is increased as a result of the reaction to form insoluble calcium sulfite.

In a further configuration of the technology, the metering device comprises a storage vessel containing the foam-forming additive and a delivery pump connected to the storage vessel. The delivery pump is connected to a foam distributor placed in the interior space of the storage housing.

The storage vessel containing the foam-forming additive is preferably placed outside the storage housing. The storage vessel may, however, also be placed inside the storage housing. The storage vessel may serve to store the foam-forming additive before the formation of the foam and the release of the foam inside the storage housing.

The provision of a storage vessel may afford the advantage that the additive can be stored spatially separately from the battery cells. The foam-forming additive can thus be removed from the storage vessel only when needed.

The delivery pump connected to the storage vessel is preferably a high-pressure pump. The use of a high-pressure pump may enable particularly quick removal of the foam-forming additive from the storage vessel.

Furthermore, the delivery pump may be connected to a foam distributor. The technology is not further restricted in terms of the foam distributor. In general, use can be made of any foam distributor known from the prior art that is suitable for releasing a foam-forming additive, in particular a foam-forming additive including a foaming agent, at least one base and optionally further additional substances, in the interior space of the storage housing.

For example, the foam distributor may comprise a line, preferably a flexible line, with nozzle outlets for distributing the foam-forming additive. The nozzles preferably make it possible to atomize the foam-forming additive, as a result of which the contact surface area between the additive and the emerging electrolyte may be advantageously increased.

In another aspect of the technology, the safety apparatus may comprise a monitoring device that comprises a battery control system and a sensor unit connected to the battery control system.

The battery control system is preferably placed outside the battery storage device. It is therefore conceivable that the battery control system monitors multiple battery storage devices. A sensor unit, which is preferably placed inside a storage housing, is connected to the battery control system.

In one embodiment, the sensor unit is selected from the group consisting of optical sensors, pressure, temperature and chemical sensors.

In one embodiment, the sensor unit is a spectroscopic gas sensor for detecting gaseous sulfur dioxide.

In a preferred embodiment, the spectroscopic gas sensor is a nondispersive infrared sensor.

If at least one battery cell exhibits anomalous behavior during operation of the battery, this can be identified by the aforementioned types of sensor. A rise in pressure or temperature or a change in the composition of the atmosphere inside the storage housing can thus be detected by the sensor unit. A battery cell defect can thus be identified directly and without complications.

In particular, a gas sensor selectively responding to sulfur dioxide enables direct information about the presence of sulfur dioxide inside the storage housing. If the gas sensor detects sulfur dioxide in the atmosphere of the storage housing, the sulfur dioxide-based electrolyte has emerged from the battery cell and the corresponding cell is thus defective.

The data collected by the sensor unit are forwarded to the battery control system connected to the sensor unit. Typically, the data sent to the battery control system are measurement data that were collected over a certain period of time.

In another aspect of the technology, the battery control system is intended to receive data from the sensor unit and evaluate the data in terms of a triggering or non-triggering scenario.

The battery control system receives the data from the sensor unit and evaluates the data in terms of the presence of a defect of a battery cell inside the storage housing. The battery control system takes the data as a basis to make a decision as to whether to initiate a triggering or non-triggering scenario. If the battery control system records anomalous data, more specifically, data that differ from the data that are to be expected, the battery control system may initiate a triggering scenario. If the data received from the sensor unit correspond to the data that are to be expected, then a non-triggering scenario may be selected.

In the event of a triggering scenario, the metering device may be actuated by the battery control system so that the foam-forming additive is released by the foam distributor, as a result of which a foam is produced inside the storage housing. In the case of a non-triggering scenario, the status quo may be maintained and the metering device is not actuated.

The process described above preferably takes place at regular intervals. The monitoring device can thus monitor the battery cells in real time, and therefore anomalous data such as pressure, temperature and atmospheric parameters inside the storage housing can be detected immediately and reliably. The battery control system can therefore also immediately take measures to release the additive inside the battery storage device to neutralize an emerging electrolyte. A safety apparatus according to this disclosure which comprises a metering device and a monitoring device may therefore be an active safety system.

In another embodiment, the metering device may comprise a mixing-in device and a circulation pump, the mixing-in device having a respective separate connection to the foam distributor, the delivery pump and the circulation pump, and the circulation pump being fluidically connected to the interior space of the storage housing.

When the foam is being released inside the storage housing, it is typically not possible to immediately fix in place and neutralize a sufficient amount of the electrolyte. The emerging electrolyte, which over time accumulates in the atmosphere of the storage housing, usually only comes into contact with the released foam as a result of gas diffusion. In this respect, the embodiment described above affords the advantage that a circulation pump may be fluidically connected to the interior space and thus to the atmosphere of the storage housing. This makes it possible to pump away the atmosphere of the storage housing and feed it back to the storage housing via the mixing-in device and the foam distributor. In other words, the atmosphere inside the storage housing may be circulated. The sulfur dioxide-based electrolyte can thus be brought into contact with the foam repeatedly. In this way, it is possible to ensure virtually complete neutralization of the electrolyte.

In another embodiment, the battery control system may be designed to actuate the metering device to activate the circulation pump in the event of a triggering scenario, so that the circulation pump extracts a gas atmosphere present in the storage housing by suction and feeds it back to the storage housing via the mixing-in device.

The gas atmosphere removed from the storage housing is preferably fed back to the storage housing via the mixing-in device and the foam distributor.

Linking the circulation pump to the monitoring device may afford the technical advantage that, in addition to the production of the foam, it is additionally also possible to control circulation of the gas atmosphere in the storage housing.

This technology also relates to a method for triggering a safety apparatus for a battery storage device of the aforementioned type, where the method may comprise the following steps:
a) detecting, via the sensor unit of the monitoring device, emergence of the electrolyte from a battery cell in the interior space of the storage housing, from which data are compiled and forwarded to the battery control system,
b) evaluating the data by means of the battery control system in terms of the presence of a triggering or non-triggering scenario,
c) identifying a triggering scenario,
d) actuating the metering device,
e) producing a foam from the foam-forming additive,
f) releasing the foam in the interior space of the storage housing,
g) optionally waiting for a period of time, and
h) optionally activating a circulation pump, which extracts a gas atmosphere present in the interior space of the storage housing by suction and feeds it back to the interior space via the mixing-in device and the foam distributor.

A safety apparatus with the aforementioned method can thus react immediately to an electrolyte emerging from a battery cell and take countermeasures. The foam released makes it possible to fix the sulfur dioxide-based electrolyte in place and the base present in the foam can react with the electrolyte, in particular with sulfur dioxide, in a neutralization reaction. The electrolyte can thus be reliably prevented from being transferred to the surrounding area.

The invention will be described in more detail below on the basis of exemplary embodiments with reference to the appended drawings.

### BRIEF DESCRIPTION OF THE DRAWINGS

FIG. 1 shows a schematic illustration of a battery storage device comprising battery cells, a metering device and a monitoring device;

FIG. 2 shows a schematic illustration of the battery storage device from FIG. 1 during active operation in the event of an electrolyte emerging from a defective battery cell;

FIG. 3 shows a schematic illustration of a gas sensor for selectively detecting gaseous sulfur dioxide;

FIG. 4 shows an example of a suitable measurement range for the gas sensor from FIG. 3; and

FIG. 5 shows a schematic flow diagram of the steps of a method for triggering a safety apparatus for a battery storage device from FIG. 1.

### DETAILED DESCRIPTION OF THE DRAWINGS

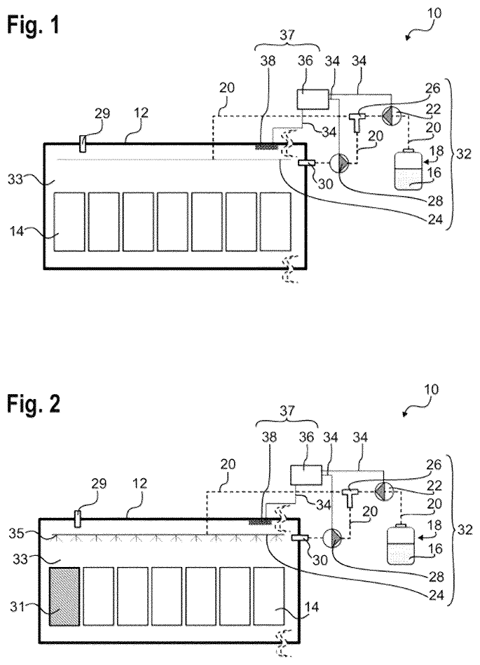

FIG. 1 shows a battery storage device 10 comprising a safety apparatus 32, 37. The safety apparatus 32, 37 comprises a metering device 32 and a monitoring device 37.

The battery storage device 10 additionally comprises a storage housing 12 and multiple battery cells 14 placed in the interior space 33 of the storage housing 12. The storage housing 12 is in particular gas-tight.

At least one battery cell 14 is placed in the interior space 33. However, any desired number of battery cells 14 may be placed inside the storage housing 12. The battery cells 14 may be connected to one another (not shown here), in order to make a higher-energy battery available.

The battery cells 14 contain at least one sulfur dioxide-based electrolyte (not shown here). In general, the technology is not further restricted in terms of the battery cell 14 provided that the battery cell 14 comprises sulfur dioxide as electrolyte.

For example, battery cells 14 comprising an electrolyte composition from WO 2021 019 042 A1, WO 2015/043573 A2 or German patent application no. 10 2021 118 811.3, unpublished on the priority date of the present application, can be used.

The metering device 32 comprises a storage vessel 18, which is placed outside the storage housing 12.

The storage vessel 18 contains a foam-forming additive 16.

The foam-forming additive 16 may be present in an aqueous solution and may comprise the following components:
(A) at least one foaming agent selected from the group consisting of an ionic surfactant, a saponin and a protein, and combinations of these,
(B) at least one base selected from the group consisting of a carbonate, hydrogen carbonate, an oxide, a hydroxide, and combinations of these, and
(C) optionally further additional substance(s) selected from the group consisting of an alkali earth metal chloride, a flame retardant, a higher alcohol, urea, and combinations of these.

The storage vessel 18 may contain an amount of the foam-forming additive 16 that is sufficient to neutralize the sulfur dioxide present in the battery cells 14. The storage vessel 18 preferably contains an amount of the foam-forming additive 16 that is sufficient to completely neutralize the sulfur dioxide present in at least one battery cell 14. The storage vessel 18 particularly preferably contains excess foam-forming additive 16 with respect to the sulfur dioxide-based electrolyte present in at least one of the battery cells 14. The latter case is advantageous in particular, because upon removal of the foam-forming additive 16 from the storage vessel 18, a residual quantity of it usually remains behind in the storage vessel 18.

The storage vessel 18 may be fluidically connected by a line 20 to a delivery pump 22, which is placed outside the storage housing 12. The delivery pump 22 may in turn be connected to a mixing-in device 26, likewise placed outside the storage housing.

The mixing-in device 26 may be fluidically connected to a foam distributor 24, a circulation pump 28 and the delivery pump 22 via lines 20.

The foam distributor 24 is placed in an interior space 33 of the storage housing 12. The foam distributor 24 may be in the form of a rigid or flexible line. In addition, the foam distributor 24 can be placed anywhere inside the storage housing 12. For example, the foam distributor 24 can be mounted on an inner wall of the storage housing or fixed to an outer wall of a battery cell 14.

In addition, the foam distributor 24 has outlets (not shown here) for releasing the foam-forming additive 16. The outlets may be in the form of, for example, nozzles which distribute the foam-forming additive 16 in the interior space 33 of the storage housing 12. The release of the foam-forming additive 16 produces the foam 35 according to this disclosure for neutralizing the electrolyte. The foam 35 is produced in particular by the foam-forming additive 16 intermixing with the atmosphere inside the storage housing 12. In particular, the gases released by an emerging electrolyte contribute to producing the foam from the foam-forming additive 16.

An outflow opening 30 is also made in a wall of the storage housing 12. The outflow opening 30 fluidically connects the interior space 33 of the storage housing 12 to the circulation pump 28. The outflow opening 30 may be in the form of, for example, a valve.

Furthermore, the safety apparatus comprises a monitoring device 37.

The monitoring device 37 comprises a battery control system 36 and a sensor unit 38, which is connected to the battery control system 36 and is placed inside the storage housing 12.

The sensor unit 38 may be placed anywhere inside the storage housing 12. It is therefore conceivable for the sensor unit 38 to be fixed to an inner wall of the storage housing 12. The sensor unit 38 may, however, also be fastened directly to a battery cell 14.

In a variant of the technology, multiple sensor units 38 may also be placed at any locations inside the storage housing 12. Various regions of the battery storage device 10 can thus be monitored by the sensor unit 38.

The technology is not further restricted in terms of the sensor unit 38. It is possible to use any sensor units that are known in the prior art and are suitable for detecting a difference in pressure, temperature or atmosphere.

The sensor unit is preferably a sensor for selectively detecting sulfur dioxide, preferably gaseous sulfur dioxide, in an atmosphere. Any sensor known in the prior art can be used for this.

For example, an indicator known from U.S. Pat. No. 4,222,745 for detecting sulfur dioxide flowing out of a battery can be used. It consists of potassium dichromate adsorbed on finely divided silica and a polymeric adhesive material, for example polydimethylsiloxane, as stabilizing matrix. For intensive color perception, titanium dioxide can also be added. Upon contact with sulfur dioxide, this indicator changes color.

Also conceivable is a detector, known from WO 02 079 746, consisting of powdered potassium dichromate applied to an adhesive strip together with an oxidation accelerator and a metal oxide inhibitor, which makes it possible to detect, inter alia, sulfur dioxide.

A sensor for detecting gaseous sulfur dioxide is also known from U.S. Pat. No. 6,579,722, where a chemiluminescent reagent is immobilized in a polymer film. The chemiluminescence resulting from contact with sulfur dioxide is detected using a photomultiplier tube or a photoelectric element.

Use can also be made of a sensor from JP 2003035705, which is suitable for detecting sulfur dioxide in a gaseous sample and which tracks optical transmission in the UV/VIS/IR range under the action of analytes. The sensor consists of a combination of orange-1 and amines and also a combination of iron ammonium sulfate, phenanthroline and acids.

EP 0 585 212 also discloses a sensor which is in the form of a sensor membrane for detecting sulfur dioxide. For this, use is made of transition metal complexes comprising rubidium, osmium, iridium, rhodium, palladium, platinum or rhenium as central atom; 2,2′-bipyridine, 1,10-phenanthroline or 4,7-diphenyl-1,10-phenanthroline as ligand; and perchlorate or chloride or sulfate as counter-anion. The polymer matrix comes from the group consisting of cellulose derivatives, polystyrenes, polytetrahydrofurans or derivatives of these.

Use can also be made of a sensor from EP 0 578 630, which provides a sensor membrane of optical sensors for detecting sulfur dioxide. For this, pH indicators, such as the fluorescent dye quinine or the absorption dye bromocresol purple, are immobilized with counter-ions, such as long-chain sulfonate ions or ammonium ions with long-chain radicals, in a polymer matrix of polyvinyl chloride.

An optical sensor for selectively detecting gaseous sulfur dioxide is particularly preferably used.

For example, use can be made of an optical sensor as is known from “Optical sensors for dissolved sulfur dioxide” (A. Stangelmayer, I. Klimant, O. S. Wolfbeis, Fresenius J., Analytical Chemistry, 1998, 362, 73-76). To detect gaseous sulfur dioxide, lipophilic pH indicators in the form of ion pairs immobilized in a gas-permeable silicon or ormosil membrane are used as sulfur dioxide sensors for gaseous samples. The pH indicators used here are ditetraalkylammonium salts with long-chain alkyl radicals of bromothymol blue, bromocresol purple and bromophenol blue. The absorption of light in the UV/VIS range is used as measurement variable.

It is also possible to use an optical sensor for quantitative identification of sulfur dioxide in a sample, as is known from DE 10 2004 051 924 A1. The sensor proposed here contains an indicator substance, which is homogeneously immobilized in a matrix of the transparent sensor, comes into at least indirect contact with the sample and changes its concentration in the presence of sulfur dioxide. This change in concentration of the indicator substance can be tracked by photometry as a change in the transmission of light in the UV/VIS range of the sensor.

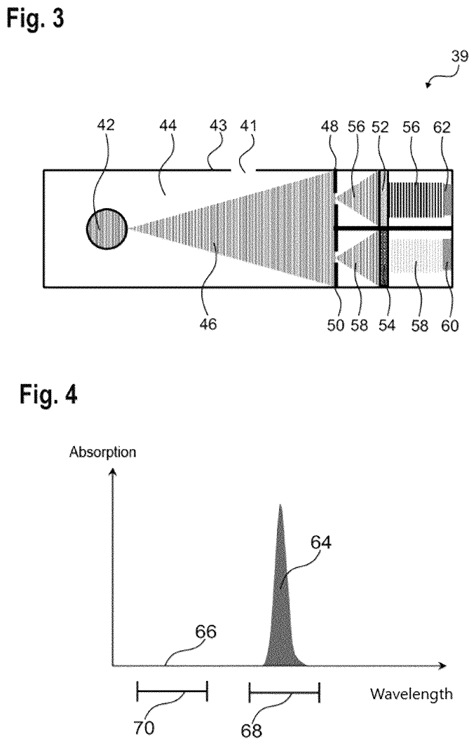

In a particularly preferred variant, the sensor for selectively detecting sulfur dioxide is a sensor as described in FIG. 3.

The sensor unit 38 is designed to detect emergence of the electrolyte from a battery cell 14, to compile data therefrom and to forward them to the battery control system 36. The data are transferred via an electrical connection 34.

The battery control system 36 may be placed outside the storage housing 12 and electrically connected to the sensor unit 38 via connections 34. The connections 34 are preferably configured to transfer electrical signals and thus the data.

The battery control system 36 is able to receive the data from the sensor unit 38 and to evaluate them in terms of a triggering or non-triggering scenario. If the battery control system records anomalous data in terms of a change in temperature, pressure or atmosphere inside the storage housing 12, the battery control system 36 initiates a triggering scenario.

The battery control system 36 is electrically connected to the delivery pump 22 via a connection 34. In the event of a triggering scenario, the battery control system 36 can selectively actuate the delivery pump 22 so that the delivery pump 22 is activated and extracts the foam-forming additive 16 from the storage vessel 18. The foam-forming additive 16 thus leaves the storage vessel 18 via the lines 20 and the delivery pump 22 and enters the foam distributor 24, which lastly releases the foam-forming additive 16 in the interior space 33 of the storage housing 12 and thus produces a foam 35.

After waiting for a period of time, the battery control system 36 can activate the circulation pump 28 via an electrical connection 34, so that the atmosphere of the interior space 33 may be extracted by suction and fed back to the interior space 33 via lines 20, the mixing-in device 26 and the foam distributor 24. This results in circulation of the atmosphere present in the interior space 33 and non-neutralized electrolyte constituents are brought into contact with the foam 35 again.

FIG. 2 shows the battery storage device 10 from FIG. 1 in the event of a triggering scenario.

Furthermore, FIG. 2 contains the same components as were already described in FIG. 1.

A description of the mechanism of a triggering scenario on the basis of FIG. 2 will be given below. If an electrical, thermal or chemical defect in a battery cell 14 arises, under certain circumstances the relevant cell 14 can open. Such a battery cell 14 is thus a defective cell 31. However, damage to a cell 14 can also occur without the cell opening at the same time. In both cases, however, a parameter in the interior space of the storage housing 12, such as temperature, pressure, electrical properties of the cells or the composition of the atmosphere, will necessarily change. A change in these parameters is detected by a sensor unit 38.

In the case of a defective cell 31 opening, emergence of a sulfur dioxide-based electrolyte can occur. The electrolyte may enter the interior space 33 of the storage housing 12 either in liquid or gaseous form. The sensor unit 38 detects the presence of such an electrolyte in liquid or gaseous form inside the storage housing in the form of differing parameters, as described above. These differing parameters are sent to the battery control system 36 as anomalous parameters in the form of data. The battery control system 36 continuously compares the data received with the data that are to be expected. If a predefined difference between the received data and the data that are to be expected is found, the battery control system 36 initiates a triggering scenario. The foam-forming additive 16 is thereupon removed from the storage vessel 18 by a delivery pump 22 and fed to the foam distributor 24. The foam distributor 24 releases the foam-forming additive into the interior space 33 of the storage housing 12. This release causes the electrolyte in the interior space 33, the released foam-forming additive 16, and the atmosphere present in the storage housing 12 to intermix. This produces a foam 35, which is deposited in the interior space 33. The foam 35 may both fix the electrolyte in place and neutralize it in an acid/base reaction.

FIG. 3 shows a sulfur dioxide sensor on the basis of a twin-beam spectrometer.

The gas sensor 39 has a detector chamber 44 enclosed by a detector housing 43. Furthermore, the detector housing 43 has a gas inlet opening 41.

The gas inlet opening 41 fluidically connects the detector chamber 44 to the interior space 33 of the storage housing. This makes it possible for a free gas exchange to take place between the two regions and an emerging electrolyte in the storage housing 12 to be detected by the gas sensor 39.

The detector housing 43 may have an elongate form, a light source 42 being assigned to one end inside the housing.

The light source 42 is preferably an infrared light source, particularly preferably a near-infrared light source. The technology is not restricted in terms of the infrared light source. Any IR light sources known in the prior art can be used, provided they can emit at wavelengths suitable for detecting sulfur dioxide in a gas atmosphere.

The light source 42 preferably emits at wavelengths in the range between 400-1800 cm⁻¹, particularly preferably between 450-600 cm⁻¹, 1100-1200 cm⁻¹ and/or 1300-1400 cm⁻¹. During operation, the light source 42 may emit an NIR beam 46 with a continuous spectrum of wavelengths in the aforementioned range.

The NIR beam 46 emitted by the light source 42 may be split into two spatially separate NIR beams by a measurement-beam stop 48 placed in the detector chamber 44 and a reference-beam stop 50. More specifically, the NIR beam 46 may be split into a measurement beam 56 by the measurement-beam stop 48 and a reference beam 58 by the reference-beam stop 50. Two separate beam paths may thus be created by the stops.

After passing through the measurement-beam stop 48, the measurement beam 56 may be incident on a measurement-beam filter 52. After passing through the reference-beam stop 50, the reference beam 58 may be incident on a reference-beam filter 54.

Suitable measurement-beam filters 52 and the reference-beam filter 54 are, for example, bandpass filters, preferably narrow-band filters. For example, the bandpass filters may have a bandwidth of 10-0.2 nm, preferably 5-0.2 nm, particularly preferably 2-0.2 nm. They are thus able to selectively filter a predefined wavelength out of the reference beam 58 and the measurement beam 56.

As reference, the transmission region of the reference-beam filter 54 may be selected such that it is permeable in a narrow range of the spectrum in which neither sulfur dioxide nor other molecules, such as carbon dioxide, have absorption bands.

For the measurement-beam filter 52, which is to say that for the measurement beam 56, the transmission range may be selected such that it falls within a range where only sulfur dioxide, but not other gases that could distort the measurement signal, is/are absorbed.

Examples of suitable wavelengths of the measurement-beam filter are: 1.56 μm, 1.57 μm, 1.58 μm, 2.46 μm and 4.02 μm.

After passing through the measurement-beam filter 52, the measurement beam 56 may be incident on a measurement-beam detector 62 downstream of the measurement-beam filter 52. Similarly, the reference beam 58 may be incident on a reference-beam detector 60 downstream of the reference-beam filter 54.

To detect the wavelengths allowed through by the filters, for example, thermocouple-based detectors may be suitable. They are able to convert heat energy directly into electrical energy, as a result of which very small thermal stresses can be generated and thus detected. The detectors used in this way thus operate particularly precisely and may be suitable for detecting even small amounts of sulfur dioxide in an atmosphere.

FIG. 4 shows a measurement range of a sulfur dioxide sensor from FIG. 3, absorption being plotted against a wavelength. The sum total of the absorption of the measurement-beam and reference-beam detectors 60, 62 is illustrated.

The measurement-beam detector 62 detects the measurement signal 64 in a measurement wavelength range 68, while the reference-beam detector 60 detects the reference signal 66 in a reference wavelength range 70. The reference wavelength range 70 and measurement wavelength range 68 are predefined by the choice of beam filter. Similarly, the width of the measured wavelength ranges depends on the choice of beam filter and is generally 10-0.2 nm, preferably 5-0.2 nm, particularly preferably 2-0.2 nm. If the measurement-beam detector 62 detects a measurement signal 64, then there is sulfur dioxide in the atmosphere of the detector chamber 44 and thus also in the interior space of the storage housing 12. For positive evidence of sulfur dioxide, a threshold value typically above the background noises of the detector can be defined.

The advantage of the twin-beam spectrometers illustrated is that they are compact and thus can be accommodated inside the storage housing 12 with a saving on space. In addition, sulfur dioxide may be detected by spectroscopy, and therefore the evaluation and conversion to electronic information is made easier in comparison with conventional methods.

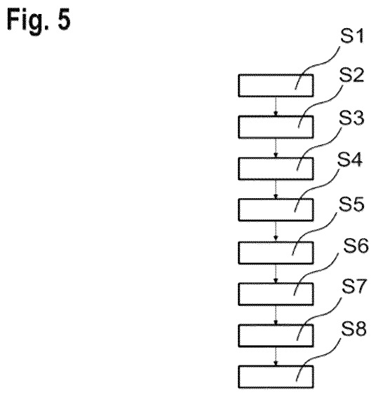

FIG. 5 shows a schematic flow diagram of the steps of a method for triggering a safety apparatus for a battery storage device 10 described above.

In the first step, emergence of an electrolyte from a battery cell is detected (step 1). The detection is done by means of a sensor unit of the monitoring device, the sensor unit being placed inside the storage housing. The sensor unit compiles data and sends them to the battery control system.

After this, the data are evaluated by the battery control system in terms of the presence of a triggering or non-triggering scenario (step 2). In so doing, the battery control system evaluates the parameters measured by the sensor unit by comparing them with the parameters that are to be expected.

If the parameters differ and this difference is outside a tolerance range, a triggering scenario is performed (step 3). The tolerance range depends on various factors, such as the selection of the detector or the form of the beam path, and is therefore selected depending on the structure of the battery storage device or the gas sensor.

After this, the metering device is actuated by the battery control system, activating a delivery pump. The delivery pump removes the foam-forming additive from the storage vessel and feeds it to a foam distributor placed inside the storage housing (step 4).

In the next step, the foam distributor produces a foam from the foam-forming additive by bringing the foam-forming additive into contact with the atmosphere of the interior space of the storage housing (step 5).

After this, the foam produced is released inside the storage housing (step 6).

Then, it is optionally possible to wait for a period of time (step 7). This may be advantageous in particular, since the waiting time gives the foam and the emerging electrolyte a certain time in which to react and during which neutralization can take place.

After waiting for a period of time, a circulation pump can optionally be activated (step 8). The circulation pump makes it possible to extract the gas atmosphere present in the storage housing by suction and to feed it back to the storage housing via the mixing-in device and the foam distributor. This makes it possible to circulate the gas atmosphere in the interior space. In this way, the emerging electrolyte that has accumulated in the atmosphere of the interior space can be efficiently brought into contact with the released foam. The circulation pump preferably operates until the sensor unit no longer detects any electrolytes in the interior space.

1-10. (canceled)

11. A battery storage device comprising:
a storage housing and one or more battery cells positioned in an interior space of the storage housing, each battery cell containing a sulfur dioxide-based electrolyte; and
a safety apparatus with a metering device configured to produce and release a foam in the interior space of the storage housing for neutralizing the electrolyte.

12. The battery storage device according to claim 11, wherein the metering device comprises a foam-forming additive for forming the foam.

13. The battery storage device according to claim 12, wherein
the foam-forming additive is present in an aqueous solution and comprises:
at least one foaming agent selected from the group consisting of an ionic surfactant, a saponin, a protein, and combinations thereof, and
at least one base selected from the group consisting of a carbonate, hydrogen carbonate, an oxide, a hydroxide, and combinations thereof.

14. The battery storage device according to claim 13, wherein the foam-forming additive further comprises:
an additional substance selected from the group consisting of an alkali earth metal chloride, a flame retardant, a higher alcohol, urea, and combinations thereof.

15. The battery storage device according to claim 12, wherein the metering device comprises:
a storage vessel containing the foam-forming additive; and
a delivery pump connected to the storage vessel, the delivery pump being connected to a foam distributor positioned in the interior space of the storage housing.

16. The battery storage device according to claim 15, wherein
the metering device comprises a mixing-in device and a circulation pump, the mixing-in device having a respective separate connection to the foam distributor, the delivery pump and the circulation pump, and the circulation pump being fluidically connected to the interior space of the storage housing.

17. The battery storage device according to claim 11, wherein
the safety apparatus comprises a monitoring device, the monitoring device comprising a battery control system and a sensor unit connected to the battery control system.

18. The battery storage device according to claim 17, wherein
the sensor unit is selected from the group consisting of an optical sensor, pressure sensor, a temperature sensor, and a chemical sensor.

19. The battery storage device according to claim 18, wherein
the sensor unit comprises a spectroscopic gas sensor for detecting gaseous sulfur dioxide.

20. The battery storage device according to claim 17, wherein
the sensor unit is configured to detect emergence of the electrolyte from any the one or more battery cells, to compile data therefrom and forward them to the battery control system.

21. The battery storage device according to claim 20, wherein
the battery control system is configured to receive data from the sensor unit and evaluate them in terms of a triggering or non-triggering scenario.

22. The battery storage device according to claim 20, wherein
the battery control system is configured, in the event of a triggering scenario, to actuate the metering device, whereby the foam is produced from the foam-forming additive and is released in the interior space of the storage housing.

23. The battery storage device according to claim 22, wherein the battery control system is configured, in the event of a triggering scenario, to actuate the metering device to activate the circulation pump, whereby a gas atmosphere present in the storage housing is extracted by suction and fed back to the storage housing via the mixing-in device and the foam distributor.

24. A method for triggering a safety apparatus for a battery storage device, the method comprising:
providing the battery storage device according to claim 22;
detecting, via the sensor unit of the monitoring device, escape of the electrolyte from the one or more battery cells in the interior space of the storage housing;
compiling data, via the sensor unit, and forwarding the data to the battery control system;
evaluating the data, via the battery control system, in terms of the presence of a triggering or non-triggering scenario;
upon identifying a triggering scenario, actuating the metering device, whereby the foam is produced from a foam-forming additive and released in the interior space of the storage housing.

25. the method according to claim 24, further comprising:
after actuating the metering device, waiting for a period of time; and
activating a circulation pump, whereby a gas atmosphere present in the interior space of the storage housing is extracted by suction and fed back to the storage housing via the mixing-in device and the foam distributor.
